(19) United States
(12) Patent Application Publication
(10) Pub. No.: US 2010/0244703 A1
(43) Pub. Date: Sep. 30, 2010

(54) AC-DRIVEN LED LIGHTING DEVICE

(76) Inventor: DER-MING JUANG, Sindian City (TW)

Correspondence Address: LEONG C LEI, PMB # 1008, 1867 YGNACIO VALLEY ROAD, WALNUT CREEK, CA, 94598, US

(21) Appl. No.: 12/410,483

(22) Filed: Mar. 25, 2009

(51) Int. Cl. H05B 37/02; H05B 37/00

(52) U.S. Cl. 315/127; 315/294

(57) ABSTRACT

The lighting device contains a bridge circuit composed of four diodes. One of the output terminals of an AC source is connected to one of the input terminals of the bridge circuit via a first capacitor for current limiting and stabilization. The other input terminal of the AC source is connected to the other input terminal of the bridge circuit. A second capacitor is connected between the two output terminals of the bridge circuit for filtering ripples. A number of series-connected light emitting diodes are also connected between the two output terminals of the bridge circuit in a forward-biased manner. The major characteristic of the light device lies in the selection of the first capacitor which provides simple yet effective current limiting and stabilization.

### BACKGROUND OF THE INVENTION

1. Field of the Invention

The present invention generally relates to light emitting diodes, and more particularly to a lighting device driven by alternate-current voltage and using light emitting diodes as light source.

2. Description of Related Art

Light emitting diodes (LEDs) have to be driven by direct-current (DC) voltage and usually they can only sustain a driving voltage of a few volts. Therefore, to apply LEDs in household light lighting devices which are usually driven by alternate-current (AC) voltage (e.g., AC 110V or AC 220V), an AC-DC conversion circuit has to be employed. In addition, due to the LEDs' specific operating requirement, some sorts of constant-voltage and constant-current arrangements have to be employed as well. As such, additional product spacing and cost are incurred. Moreover, as conventional AC-DC circuit usually involves large amount of current, together with the power loss from the voltage conversion, unnecessary power consumption is significant.

### BRIEF SUMMARY OF THE INVENTION

Therefore, a novel AC-driven lighting device using LEDs as light source is provided herein. The lighting device has a simple circuit structure, a low production cost, an enhanced current stability, without additional power consuming and heat producing elements. The lighting device's heat dissipation requirement is therefore reduced, yet with superior reliability and operational life span.

The lighting device contains a bridge rectifying circuit consisting of four diodes. One of an AC power source's output terminals is connected one of the two input terminals of the bridge rectifying circuit via a fuse and a current-limiting first capacitor series-connected therebetween. The other output terminal of the AC power source is directly connected to the bridge rectifying circuit's other input terminal. The two output terminals of the bridge rectifying circuit, on one hand, are connected the two terminals of a filtering second capacitor, respectively, and, on the other hand, have multiple series-connected LEDs therebetween. The LEDs are forward-biased between the output terminals of the bridge rectifying circuit so as to function as the lighting source of the lighting device when the lighting device is turned on.

The bridge rectifying circuit transforms the sinusoidal AC voltage into rippled DC voltage. The second capacitor filters and stabilizes the rippled DC voltage. The gist of the present invention is about the configuration and choice of the first capacitor. By having an appropriate capacitance, the first capacitor is able to provide simple yet very effective current limiting and steadiness.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing the circuit of a lighting device according to an embodiment of the present invention.

FIG. 2 is a schematic diagram showing an equivalent circuit of the circuit of FIG. 1.

FIG. 3 is a schematic diagram showing the circuit of a lighting device according to another embodiment of the present invention.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

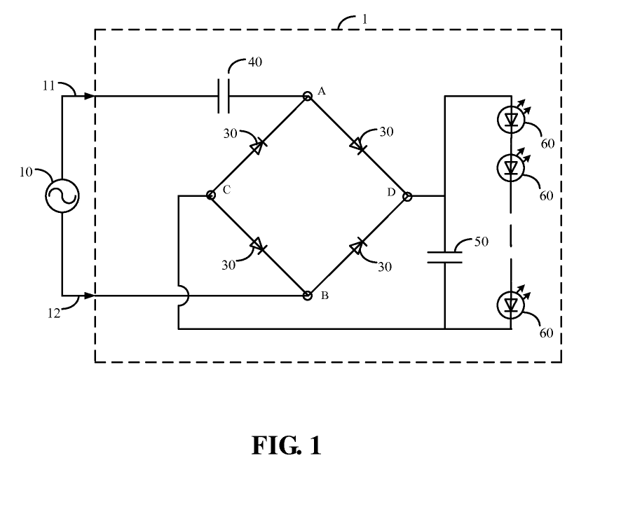

FIG. 1 is a schematic diagram showing the circuit of a lighting device according to an embodiment of the present invention. As illustrated, the lighting device 1's two input terminals (not numbered) are directly connected to the two output terminals 11 and 12 of an AC power source 10 (e.g., 60 Hz, 110V), respectively.

The lighting device 1 contains a bridge rectifying circuit consisting of at least four diodes 30. For persons skilled in the related arts, the structure of a bridge rectifying circuit should be quite straightforward. One of the output terminals (e.g., terminal 11) of the AC power source 10 is connected to one of the two input terminals (e.g., terminal A) of the bridge rectifying circuit via a first capacitor 40. The other output terminal (e.g., terminal 12) of the AC power source 10 is directly connected to the other input terminal (e.g., terminal B) of the bridge rectifying circuit.

Between the two output terminals C and D of the bridge rectifying circuit, on one hand, there is second capacitor 50, and, on the other hand, multiple LEDs 60 are series-connected therebetween. Please note that these LEDs 60 are forward-biased so that they function as the lighting device 1's light source when current is conducted through.

The bridge rectifying circuit made by the diodes 30 turns the sinusoidal AC voltage from the AC power source 10 into rippled DC voltage. The purpose of the second capacitor 50 further filters and stabilizes the rippled voltage. As to the first capacitor 40, its purpose is for current limiting and steadiness.

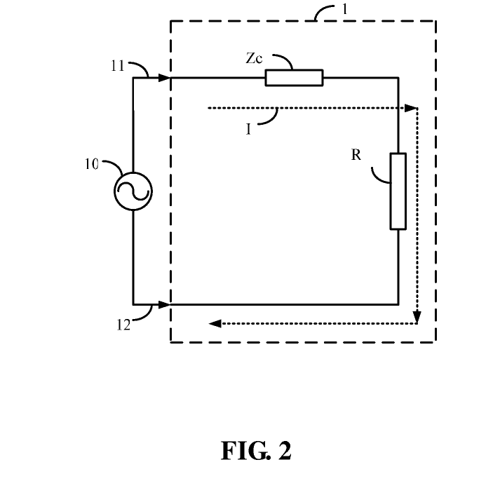

The configuration and choice of the first capacitor 40 is the gist of the present invention. To determine an appropriate capacitance for the first capacitor 40, the circuit shown in FIG. 1 could be considered in terms of an equivalent circuit shown in FIG. 2. As illustrated, the circuit element having capacitive reactance Zc represents the first capacitor 40 while the circuit element having impedance R represents the plural LEDs 60. Assuming each LED 60 is one of 0.1 W, its operating voltage is around 3.0V and the operating current I is about 20 mA. Therefore, each LED 60 has an impedance 15Ω (3.0V/0.02 A). Further assuming that there are 18 LEDs 60, then R=2,700Ω. If the power source 10 provides 60 Hz, 110V AC voltage, then 20 mA=110V/(Zc+2,700Ω) and Zc=2,652Ω. As Zc=1/2 πfC (where f is the frequency of the AC voltage and C is capacitance of the first capacitor 40), C could be calculated to be 1 μF (2.652Ω=1/2π60C). In other words, the capacitance of the first capacitor 40 could be determined by the number, the operating voltage, operating current of the LEDs 60, and the effective voltage and the frequency of the AC power source 10. Compared to the conventional AC-DC circuit, the current limiting mechanism (i.e., the first capacitor 40) of the present invention is significantly simpler and more effective.

The other function of the first capacitor 40 is for steadying the current. According to the characteristics of the LEDs, their equivalent impedance (e.g., 150Ω as calculated above) would decrease as the temperature rises up. This would lead to the increase of the operating current I. However, the additional operating current I would be absorbed by the first capacitor 40 and an increase of the voltage across the first capacitor 40. As the voltage from the AC power source 10 is constant, lesser voltage is divided and applied to the LEDs 60, pulling the rising operating current I back and thereby achieving current steadiness. According to experiment, when the temperature rises from room temperature to 60° C., the variation of the operating current I is less than 1 mA. However, if without the first capacitor 40, the operating current I would be increased from 20 mA up to 40 mA. The LEDs 60 would enter a positive feedback loop as more operating current incurs higher temperature which in turn causes a further increase of the operating current. This feedback loop reinforces itself until the LEDs 60 are burnt down.

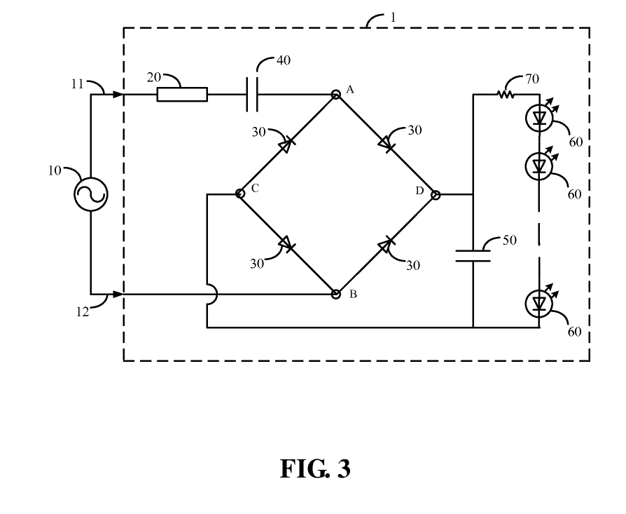

FIG. 3 provides illustration to another embodiment of the present invention. Compared to what is shown in FIG. 1, the differences are: (1) one of the output terminals (e.g., terminal 11) of the AC power source 10 is connected to one of the two input terminals (e.g., terminal A) of the bridge rectifying circuit via series-connected first capacitor 40 and fuse 20; and (2) between the two output terminals C and D of the bridge rectifying circuit and the LEDs 60, an additional, series-connected current limiting resistor 70 is provided.

The provision of power from a conventional AC-DC circuit to the LEDs is one of low voltage (usually lower than 24V), low impedance, and large current. In contrast, the present invention is one of high voltage, high impedance, and low current. A comparison table between the present invention and the conventional AC-DC circuit is as follows.

| | Conventional AC-DC | |
|---|---|---|
| | Circuit | Present Invention |
| Circuit Structure | Complex | Simple |
| Manner of load | parallel connections, or | Series connection |
| connection | combined parallel and | |
| | series connection | |
| Constant current | Good | Good |
| performance | | |
| Cost | High | Low |
| Dimension | Medium | Rather small |
| Conversion | 80~85% | Over 98% |
| efficiency | | |
| Power factor | 65% (if there is no | 70% |
| | additional arrangement for | |
| | boosting power factor) | |
| Heat dissipation | High | Low |
| requirement | | |
| High frequency | Yes | No |
| electromagnetic | | |
| radiation | | |
| Reliability and | Medium | High |
| operational life span | | |

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A lighting device directly connected to an AC power source's two output terminals, comprising:
a bridge rectifying circuit formed by at least four diodes, said bridge rectifying circuit having two input terminals and two output terminals, one of said output terminals of said AC power source connected to one of said input terminals of said bridge rectifying circuit;
a first capacitor for current limiting and steadiness connected between the other output terminal of said AC power source and the other input terminal of said bridge rectifying circuit;
a second capacitor for ripple filtering connected between said output terminals of said bridge rectifying circuit; and
a plurality of LEDs forward-biased and series-connected between said output terminals of said bridge rectifying circuit.

2. The lighting device according to claim 1, further comprising a fuse series-connected to said first capacitor so that said fuse and said first capacitor are connected between the other output terminal of said AC power source and the other input terminal of said bridge rectifying circuit.

3. The lighting device according to claim 1, further comprising a resistor series-connected to said LEDs; and said LEDs and said resistor are series-connected between said output terminals of said bridge rectifying circuit.
